(19) United States
(12) Patent Application Publication
(10) Pub. No.: US 2026/0222905 A1
(43) Pub. Date: Jul. 30, 2026

(54) METHODS, COMMUNICATIONS DEVICES, AND INFRASTRUCTURE EQUIPMENT

(71) Applicant: Sony Group Corporation, Tokyo (JP)

(72) Inventors: Vivek SHARMA, Surrey (GB); Yassin Aden AWAD, Uxbridge (GB); Yuxin WEI, Basingstoke (GB); Hideji WAKABAYASHI, Hampshire (GB)

(73) Assignee: Sony Group Corporation, Tokyo (JP)

(21) Appl. No.: 19/150,199

(22) PCT Filed: Feb. 7, 2024
(86) PCT No.: PCT/EP2024/053012

§ 371 Date: Jul. 23, 2025

(30) Foreign Application Priority Data
Feb. 10, 2023 (EP) 23156160.6

(51) Int. Cl. H04W 28/02

(52) U.S. Cl. CPC H04W 28/0278; H04W 28/0252

(57) ABSTRACT

A method of transmitting data by a communications device via a wireless communications network is provided. The method comprises receiving, at a transmit buffer, data for transmission via a wireless access interface of the wireless communications network, determining, an initial buffer size required for transmitting the data based on an amount of data in the transmit buffer, reporting an initial buffer status to an infrastructure equipment based on the absolute value of the initial buffer size, determining an updated buffer size required for data transmission based on changes to the amount of data in the transmit buffer, and reporting an updated buffer status to the infrastructure equipment based on the difference in the updated buffer size and the initial buffer size.

### BACKGROUND

### Field of Disclosure

The present disclosure relates to communications devices, infrastructure equipment and methods for the transmission and reception of data via a wireless communications network and for the reporting of buffer status. The present application claims the Paris convention priority of European patent application number EP23156160.6 filed on 10 Feb. 2023 the contents of which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

3GPP defined wireless communications systems are able to support more sophisticated services than simple voice and messaging services offered by previous generations of mobile telecommunication systems. For example, with the improved radio interface and enhanced data rates provided by UMTS and Long Term Evolution (LTE) systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example, it is expected future wireless communications networks will be expected to support efficiently communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support buffer status reporting for use in scheduling uplink data transmission in a wireless communication network.

### SUMMARY OF THE DISCLOSURE

The present disclosure can help address or mitigate at least some of the issues discussed above.

Embodiments of the present technique can provide a method of transmitting data by a communications device via a wireless communications network. The method comprises receiving, at a transmit buffer, data for transmission via a wireless access interface of the wireless communications network, determining, an initial buffer size required for transmitting the data based on an amount of data in the transmit buffer, reporting an initial buffer status to an infrastructure equipment based on the absolute value of the initial buffer size, determining an updated buffer size required for data transmission based on changes to the amount of data in the transmit buffer, and reporting an updated buffer status to the infrastructure equipment based on the difference in the updated buffer size and the initial buffer size.

Example embodiments can also provide a method of receiving data by an infrastructure equipment via a wireless communications network, the method comprises receiving an initial buffer status from a communications device, determining an initial buffer size for receiving the data based on the initial buffer status, receiving an updated buffer status from the communications device, determining the difference in an updated buffer size and the initial buffer size based on the updated buffer status, and determining the updated buffer size for data reception by adding the difference to the initial buffer size.

5G extended reality (XR) services is a combination of 5G network technology and extended reality (XR) technologies such as virtual reality (VR), augmented reality (AR) and mixed reality (MR). Buffer status reporting is conventionally performed based on a Buffer Status (BS) table which contains a mapping of buffer size levels computed by a data volume calculation procedure according to TS 38.322 [2] and TS 38.323 [3], with buffer size fields of buffers status report (BSR). In view of the requirements of better scheduling of UEs using XR services, there is a need for enhanced buffer status reporting to provide increased accuracy for compression and prediction of buffer size.

Embodiments of the present technique can provide enhanced buffer status reporting with reduced quantization errors and increased accuracy for compression and prediction of buffer size. Accordingly, the capacity gain can be enhanced and better scheduling of UEs can be achieved.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system, which may be configured to operate in accordance with certain embodiments of the present disclosure;

FIG. 2 schematically represents some aspects of a new radio access technology (RAT) wireless telecommunications system, which may be configured to operate in accordance with certain embodiments of the present disclosure;

FIG. 3 is a schematic block diagram showing entities within a communications device and an infrastructure equipment which may be configured to operate in accordance with example embodiments of the present technique;

FIG. 4 illustrates a flow chart for a process carried out by a communications device in accordance with example embodiments of the present technique;

FIG. 5 illustrates a flow chart for a process carried out by an infrastructure equipment in accordance with example embodiments of the present technique;

FIG. 6 is a schematic block diagram showing a modelling entity within a communications device adapted in accordance with example embodiments of the present technique;

FIG. 7 is a schematic block diagram showing a modelling entity within an infrastructure equipment adapted to operate in accordance with example embodiments of the present technique;

FIG. 8 is a schematic block diagram showing modelling entities within a communications device and an infrastructure equipment adapted in accordance with example embodiments of the present technique; and

FIG. 9 illustrates a flow chart for a process carried out by a modelling entity within a communications device and an infrastructure equipment adapted in accordance with example embodiments of the present technique.

### DETAILED DESCRIPTION OF THE EMBODIMENTS

### Long Term Evolution Advanced Radio Access Technology (4G)

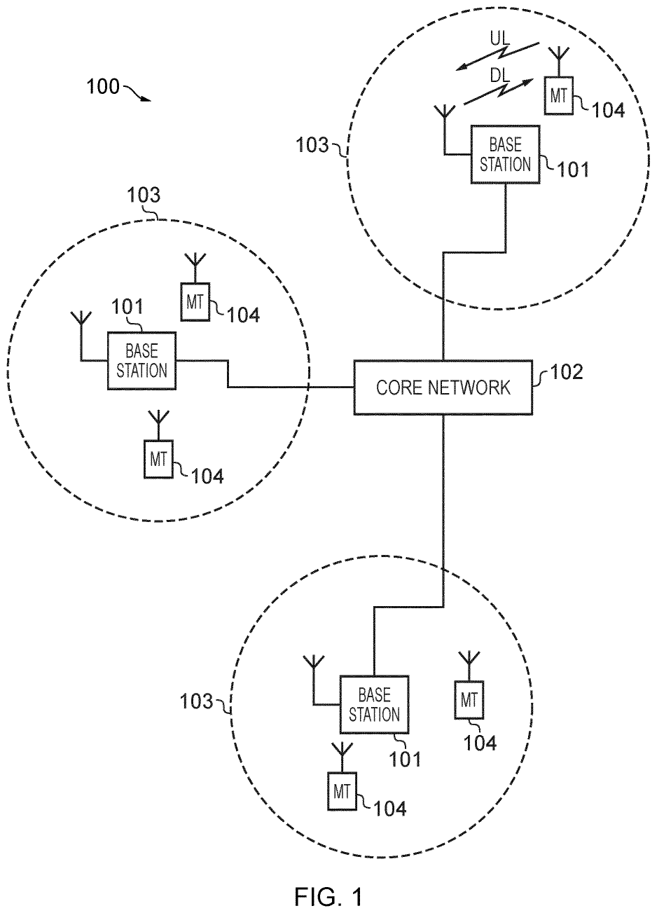

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [4]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

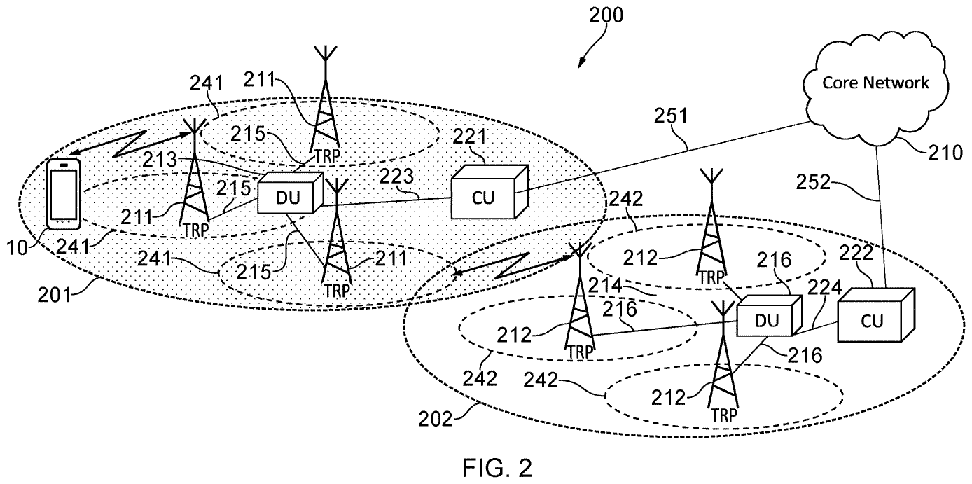

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

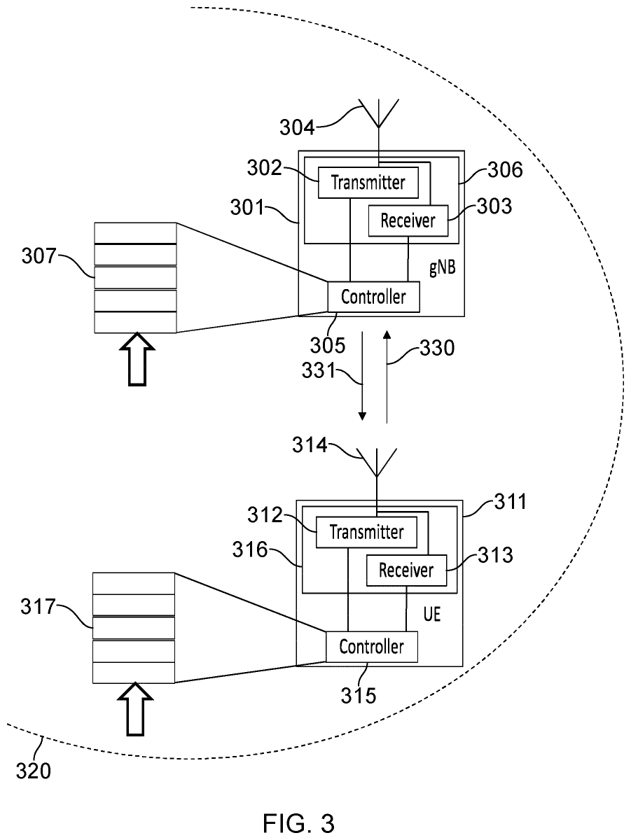

In a 5G network, a CU 221 in combination with one or more DUs 213, 216 and one or more TRPs 211, 212 can form a base station or gNB 301 of a radio network part of the 5G radio access network (RAN). In FIG. 3, a gNB 301, formed from one or more TRPs 211, 212, one or more DUs 213, 216 and CU 221 can be represented in a simplified form as comprising, transmitter circuitry 302, receiver circuitry 303, an antenna 304 and a controller circuit or controlling processor 305 which may operate to control the transmitter 302 and the wireless receiver 303 to transmit and receive radio signals to one or more UEs 311 within a cell 320. The transmitter circuit 302 and the receiver circuit 303 may be implemented together to form a wireless transceiver 306. As shown in FIG. 3, an example UE 301 is shown to include corresponding receiver circuitry 313, transmitter circuitry 312, an antenna and controller circuitry 315. The transmitter circuit 312 and the receiver circuit 313 may be implemented together to form a wireless transceiver 316. The controller circuitry 315 is configured to control the transmitter circuitry 312 to transmit signals representing uplink data to the wireless communications network via the wireless access interface formed by the gNB 301 as represented by an arrow 330. The controller circuitry or controlling processor 315 is also configured to control the receiver circuitry 313 to receive downlink data as signals transmitted by the transmitter 302 represented by an arrow 331 and received by the receiver 313 in accordance with the conventional operation.

The transmitter circuits 302, 312 and the receiver circuits 303, 313 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 305, 315 (as well as other controllers described in relation to examples and embodiments of the present disclosure) may be, for example, a microprocessor, a CPU, or a dedicated chipset, etc., configured to carry out instructions, which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

### Buffer Status Report

Also shown in FIG. 3 a UE 311, when using a PUSCH scheduled by an Uplink Grant from a gNB 301 to transmit its uplink data at its transmit buffer 317, may be configured to send a Buffer Status Report (BSR) in the scheduled PUSCH to indicate the size of data in the transmit buffer 317 to the gNB 301 so that the gNB 301 can schedule further PUSCH for the UE 311. The gNB 301 may be configured to determine the size of a receive buffer 307 based on the BSR received from the UE 311. In some embodiments, the transmit buffer 317 in the UE 311 may be an RLC transmission buffer for temporarily storing RLC layer uplink data to be transmitted to the gNB 301.

TR 38.835 [5] discloses enhanced BS reporting schemes for sending BSRs. For example, an enhanced BS reporting scheme may support legacy dynamic scheduling with legacy BSR. In another example, an enhanced BS reporting scheme may support precise buffer size and new buffer status tables (BS table) with finer granularity, In a further example, an enhanced BS reporting scheme may provide XR-specific mechanism of BS reporting to minimize scheduling delay. TR 38.835 also describes improved capacity performance achieved by the enhanced BS reporting schemes in comparison with legacy BSR. It is concluded that BSR enhancements may include at least new BS tables and delay reporting of buffered data in uplink.

It will be appreciated that new BS reporting may support:
informing precise data rate and reducing quantization errors
delay or survival time of reported data
increased frequency of reporting BSR

A UE sends a BSR based on existing known framework as explained in MAC specification TS 38.321 [6]. XR-specific changes to BSR will require reporting of a buffer size with finer granularity, with higher number of bits, in higher frequency of reporting, and with new information such as survival time. Survival time represents the time that an application consuming a communication service may continue without an anticipated message, according to TS 22.261 [7]. In legacy reporting, BSR reporting may be periodic or event triggered, whereas in XR services, new BSR reporting may occur more frequently, for example, it may happen every scheduling period. Embodiments of the present technique is desirable for increased frequency of BSR reporting because it allows signalling of absolute and delta values and provides the benefits of reduced quantization errors and increased accuracy for compression and prediction of buffer size.

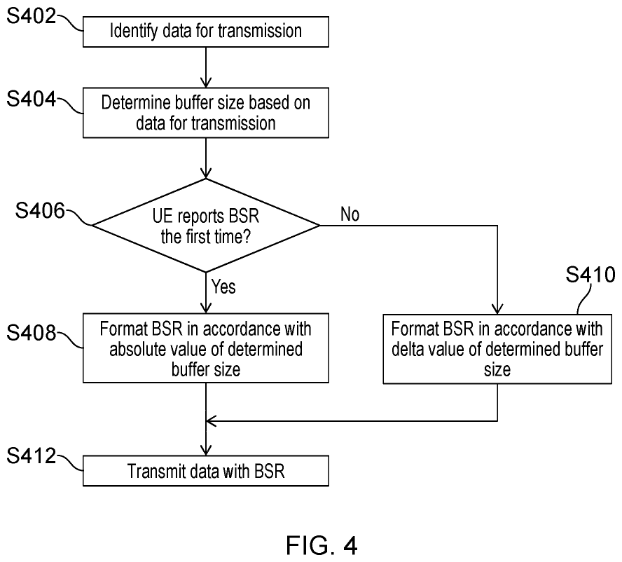

FIG. 4 illustrates a flow chart for a process carried out by a communications device (UE) 311 in accordance with embodiments of the present technique.

The process starts at step S402, in which the UE 311 identifies data for transmission. For example, an amount of data in a transmit buffer is obtained. Conventionally the transmit buffer forms part of a radio link control (RLC) layer, in which the RLC layer uses the amount of data in the transmit buffer to identify resources of the uplink which need to be allocated to the UE 311 to transmit the uplink data.

The process continues with step S404, in which a buffer size to be reported in a BSR is determined based on an amount of data in the RLC transmit buffer for transmission. For example, the amount of data may be the buffer size. In some embodiments, the UE 311 may report the actual value of the buffer size to a gNB 301. In some embodiments, the UE 311 may report a predicted value of the buffer size to the gNB 301, in which case the gNB 301 may use this predicted value for reserving resources for the near future.

At step S406, it is determined whether the UE 311 sends a BSR to the gNB 301 for the first time using a PUSCH scheduled by the gNB 301. The BSR is sent to the gNB 301 using MAC control elements (MAC-CE) and BS reporting may be triggered, for instance, when new data arrives on a logical channel that has a higher priority than the buffers were previously storing, in which case the UE 311 will send a regular BSR. If the number of padding bits during a normal PUSCH transmission has enough spare room for sending a BSR, the UE 311 will send a padding BSR. The transmission of a BSR may also be performed at regular intervals during uplink data transmission, and the UE 311 will send a periodic BSR. If it is the first time that the UE 311 sends a BSR using the PUSCH scheduled, control continues to step S408, otherwise control passes to step S410.

At step S408, the UE 311 formats the first BSR based on an absolute value of the buffer size determined in step S404.

At step S410, the UE 311 sends a delta value of the buffer size compared to this absolute value for subsequent BSRs. For example, if the UE 311 reported buffer size as 10 MB in the first BSR, then the subsequent BSR will report change in buffer status with respect to 10 MB. For example, if 8-bit buffer size field is used and the buffer status now changes to 8 MB, the eight bits in BSR MAC-CE are used to represent a finer value of delta, i.e.: 2 MB negative change of value with respect to 10 MB.

In some embodiments, a change in a buffer size is sent per logical channel so that if a buffer contains high priority data, then this high priority data is indicated, so that high priority buffered data may be cleared quickly. In this case, reference for absolute value could be the last absolute value of a reported buffer size or a new reference value such as “0”. Since the same number of bits are used to represent the delta value, the quantization error of the reported buffer size is reduced.

At step S412, the UE 311 transmits data with the BSR as MAC-CE to the gNB 301. The BSR may contain either the absolute value or the delta value of the buffer in a known format.

In some embodiments, XR requires frequent buffer status reporting and in some cases, buffer status reporting is performed in every scheduling period and the buffer does not disappear with one instance of scheduling.

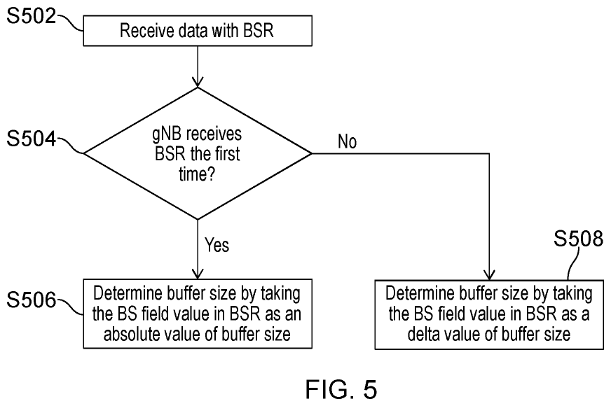

FIG. 5 illustrates a flow chart for a process carried out by an infrastructure equipment (gNB) 301 in accordance with embodiments of the present technique.

The process starts at step S502, in which data with a BSR is received by the gNB 301 from a UE 311.

At step S504, it is determined whether the gNB 301 receives a BSR the first time in a PUSCH scheduled. If yes, control continues to step S506, otherwise control passes to step S508.

As step S506, the gNB 301 regards a BS field value in the BSR as an absolute value of a transmit buffer size in the UE 311, and determines the size of its receive buffer accordingly.

As step S508, the gNB 301 regards the BS field value in the BSR as a delta value of the transmit buffer size in UE and computes a corresponding absolute value by adding the delta value to a reference buffer size obtained from the first BSR received in the PUSCH scheduled. The gNB 301 then determines the size of its receive buffer based on the computed absolute value.

TABLE 1

| Index | BS value |
|---|---|
| . . . | . . . |
| 46 | ≤181 |
| 47 | ≤193 |
| . . . | . . . |
| 243 | ≤47087187 |
| 244 | ≤46182206 |
| . . . | . . . |

Table 1 illustrates an example mapping of buffer size levels (BS value) with a buffer size field (8-bit index). It is shown that the step size increases significantly with the BS value. For example, the step size is 12 bytes when the buffer size is between 181 bytes and 193 bytes. When the buffer size gets to the range of 47087187 bytes to 46182206 bytes, the step size is increased to 2815019 bytes.

In order to represent the buffer size with higher accuracy and smaller step size, the number of bits required will have to be increased from current value of 5 bits or 8 bits in TR 38.321 to, for example, 12 bits, 16 bits or more. However, the overhead of BSR will also increase due to the extra bits. If a BSR is sent at the beginning of every scheduling period, the accumulated overhead will be significantly large. By sending a delta value of the buffer size as described in the embodiments of the present technique instead of an absolute value in a BSR, the granularity of the reported buffer size can be significantly improved and the buffer size can be communicated from the UE 311 to the gNB 301 with higher accuracy.

In some embodiments, AI/ML is used for compression and decompression of BSR in order to represent higher accuracy in the report by still using 8 bits legacy reporting, as will further be described below.

### Enhanced BSR by Artificial Intelligence/Machine Learning

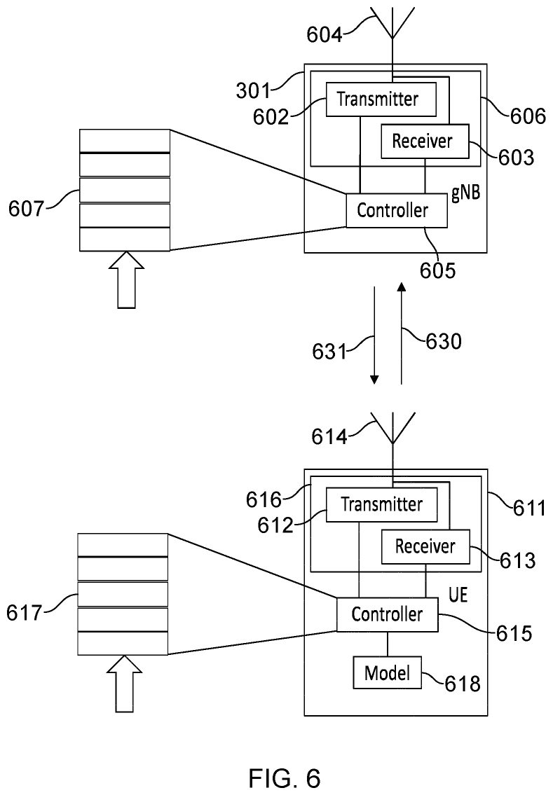

FIG. 6 is a schematic block diagram showing a modelling entity within a communications device (UE) 611 adapted in accordance with example embodiments of the present technique.

In FIG. 6, the example UE 611 is shown to include corresponding receiver circuitry 313, transmitter circuitry 612, an antenna 614, controller circuitry 615 and an artificial intelligence (AI)/machine learning (ML) model 618. The transmitter circuit 612 and the receiver circuit 613 may be implemented together to form a wireless transceiver 616. The controller circuitry 615 is configured to control the transmitter circuitry 612 to transmit signals representing uplink data to the wireless communications network via the wireless access interface formed by the gNB 601 as represented by an arrow 630. The controller circuitry 615 is also configured to control the receiver circuitry 313 to receive downlink data as signals transmitted by the transmitter 602 represented by an arrow 631 and received by the receiver 613 in accordance with the conventional operation.

When the UE 611 uses a PUSCH scheduled by an Uplink Grant from a gNB 601 to transmit its uplink data in a transmit buffer 617, it may be configured to send a BSR in the scheduled PUSCH to indicate the size of the transmit buffer 617 to the gNB 601 so that the gNB 601 can schedule further PUSCH for the UE 611. In some embodiments, the controller circuitry 615 determines the buffer size based on a model 618 derived in accordance with machine learning techniques as will be described below. The model 618 determines based on the data arriving in the transmit buffer 617, for any permitted combination of input values, a buffer size for the data to be transmitted. In some embodiments, a value of a buffer size (BS) field defining a range of buffer size may be directly determined, in which case the model 618 may apply a classification process, to classify the input values as corresponding to exactly one of the predetermined BS field values.

In some embodiments of the present technique, the UE 611 may receive a representation of the model 618, which is stored in memory (not shown) of the UE 611. Preferably, the memory is non-volatile memory.

In some embodiments, the AI/ML BSR prediction or compression algorithm take into account the following factors on the transmitter side (UE based information):
RSRP/RSRQ value
Channel Status Information (CQI and calculated SRS)
power headroom (PHR)
survival time of data
frequency of BSR Reporting
application layer status like L4S
size of current resource allocation (#RBs, MCS, TBS, etc.)

Based on one or more of these factors, the UE 611 determines the buffer size and compresses the information by encoding it into a buffer size value based on a buffer status table. The buffer size value represents an absolute value of the buffer size when a BSR is sent for the first time. For subsequent BSRs, the buffer size value represents the delta value of the updated buffer size compared to the absolute value of the buffer size reported in the first BSR.

In some embodiments, the UE 611 may use the above UE based information as well as other factors provided by the gNB 601 (gNB based information), for example:
cell load
uplink interference
application layer status like L4S

According to embodiments of the present technique, the UE side AI/ML model 618 works on the UE 611 based on the factors as mentioned above and the output of the AI/ML model 618 may be used to predict BSRs for a near future and adjust BSR reporting by taking into account the predicted value.

In some embodiments, gNB 601 may provide assistant information to the UE 611 for the UE side model 618 to work based on the gNB side parameters like gNB load, congestion and interference. The gNB 601 is transparent and will treat the predicted values and non-predicted values in the BSR in the same way.

In some embodiments, the UE 611 may indicate if the value of buffer size is predicted or actual buffer size. The gNB 601 uses this information for reserving resources for the near future if the BSR is based on predicted values. The gNB 601 may also perform sanity check for the confidence of the predicted values.

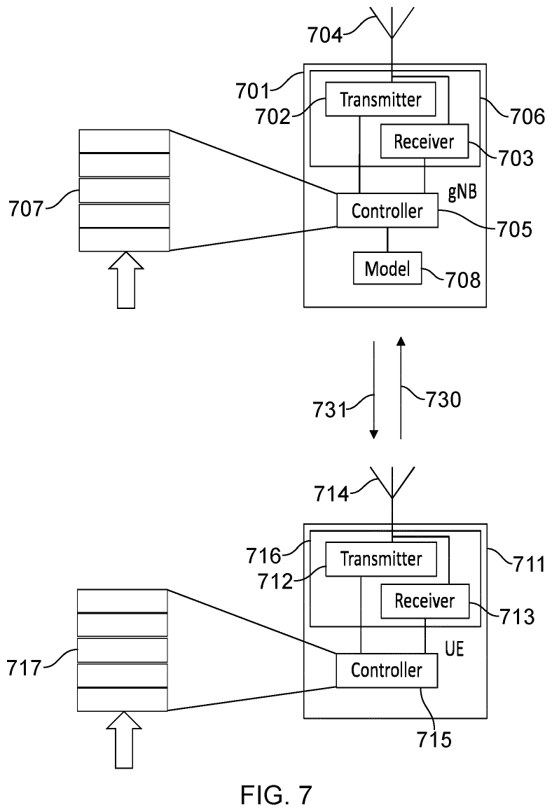

FIG. 7 is a schematic block diagram showing a modelling entity within an infrastructure equipment (gNB) 701 adapted to operate in accordance with example embodiments of the present technique.

In FIG. 7, the gNB 701 is shown to include transmitter circuitry 702, receiver circuitry 703, an antenna 704, an artificial intelligence (AI)/machine learning (ML) model 708 and controller circuitry or a controlling processor 305 which may operate to control the transmitter 302 and the wireless receiver 303 to transmit and receive radio signals to one or more UEs 711. The transmitter circuit 702 and the receiver circuit 703 may be implemented together to form a wireless transceiver 706.

When the gNB 701 receives BSR from the UE 711 on a PUSCH scheduled, it can obtain information associated with the size of a transmit buffer 717 in the UE 711. This allows the gNB 701 to allocate a receive buffer for receiving the data and schedule further PUSCH for the UE 711. In some embodiments, the controller circuitry 705 determines the buffer size based on the model 708 derived in accordance with machine learning techniques as will be described below. The model 708 determines, for any permitted combination of input values, a buffer size for the data to be received. In some embodiments, a value of a buffer size (BS) field defining a range of buffer size may be predicted, in which case the model 708 may apply a classification process, to classify the input values as corresponding to exactly one of the predetermined BS field values.

In some embodiments of the present technique, the gNB 701 may receive a representation of the model 708, which is stored in memory (not shown) of the gNB 701. Preferably, the memory is non-volatile memory.

In some embodiments, the AI/ML BSR prediction or decompression algorithm may take into account the following factors on the UE 711 (UE based information):
RSRP/RSRQ value
Channel Status Information (CQI and calculated SRS)
power headroom (PHR)
survival time of data
frequency of BSR Reporting
application layer status like L4S
size of current resource allocation (#RBs, MCS, TBS, etc.)

Based on one or more of these factors, the gNB 701 decompresses buffer size information by decoding a received buffer size value based on a buffer status table. The buffer size value represents an absolute value of the buffer size when a BSR is received for the first time. For subsequent BSRs, the buffer size value represents the delta value of an updated buffer size compared to the absolute value of the buffer size reported in the initial BSR.

In some embodiments, a decompressor in the gNB 701 may use the above UE based information as well as other factors on the gNB 701 (gNB based information), for example:
cell load
uplink interference
application layer status like LAS

According to embodiments of the present technique, the gNB 701 uses the above information as an input and then generate predicted BSRs based on the gNB side model 708 for the near future. In some embodiments, if the gNB 701 is confident about the predicted values then the gNB 701 may direct the UE 711 to skip reporting of BSRs for a certain period of time. This information or command may be sent in a MAC-CE or PHY signalling to the UE 711. The UE 711 on receiving the skip command, will skip sending BSRs for a predetermined duration.

For input data, if a PDU from PDU set is discarded then related data from logical channel should also be discarded. Any such discard of data will have an impact on prediction of BSR on the gNB side. Therefore, in some embodiments, a BSR is triggered at the next available instance of BSR reporting when a packet from PDU set is discarded.

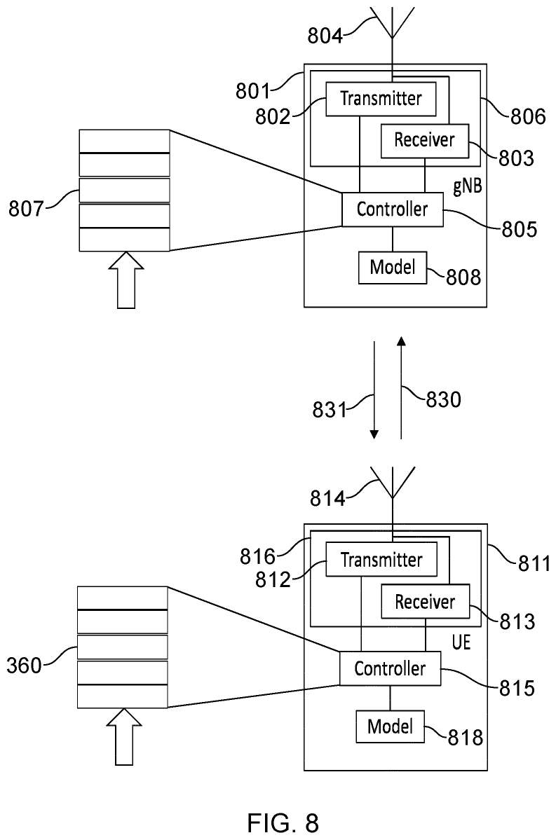

FIG. 8 is a schematic block diagram showing modelling entities within a communications device (UE) 811 and an infrastructure equipment (gNB) 801 adapted in accordance with example embodiments of the present technique.

In FIG. 8, the UE 811 is shown to include corresponding receiver circuitry 813, transmitter circuitry 812, an antenna 814, controller circuitry 815 and an artificial intelligence (AI) model 818. The transmitter circuit 812 and the receiver circuit 813 may be implemented together to form a wireless transceiver 816. The controller circuitry 815 is configured to control the transmitter circuitry 812 to transmit signals representing uplink data to the wireless communications network via the wireless access interface formed by the gNB 801 as represented by an arrow 830. The controller circuitry 815 is also configured to control the receiver circuitry 813 to receive downlink data as signals transmitted by the transmitter 802 represented by an arrow 831 and received by the receiver 813 in accordance with the conventional operation.

The gNB 801 is shown to include transmitter circuitry 802, receiver circuitry 803, an antenna 804, an AI model 808 and controller circuitry or a controlling processor 805 which may operate to control the transmitter 802 and the wireless receiver 803 to transmit and receive radio signals to one or more UEs 811. The transmitter circuit 802 and the receiver circuit 803 may be implemented together to form a wireless transceiver 806.

When the UE 811 uses a PUSCH scheduled by an Uplink Grant from the gNB 801 to transmit its uplink data in a transmit buffer 817, it may be configured to send a BSR in the scheduled PUSCH to indicate the size of the transmit buffer 817 to the gNB 801 so that gNB 801 can schedule further PUSCH for the UE 811. In some embodiments, the controller circuitry 815 determines the buffer size based on the model 818 derived in accordance with machine learning techniques as will be described below. The model 818 determines based on the data arriving in the transmit buffer 817, for any permitted combination of input values, a buffer size for the data to be transmitted. In some embodiments, a value of a buffer size (BS) field defining a range of buffer size may be directly determined, in which case the model 818 may apply a classification process, to classify the input values as corresponding to exactly one of the predetermined BS field values.

In some embodiments of the present technique, the UE 811 may receive a representation of the model 818, which is stored in memory (not shown) of the UE 811. Preferably, the memory is non-volatile memory.

When the gNB 801 receives a BSR from the UE 811 on a PUSCH scheduled, it can obtain information associated with the size of the transmit buffer 817 in the UE 811. This allows the gNB 801 to allocate a receive buffer for receiving the data and schedule further PUSCH for the UE 811. In some embodiments, the controller circuitry 805 determines the buffer size based on the model 808 derived in accordance with machine learning techniques as will be described below. The model 808 determines, for any permitted combination of input values, a buffer size for the data to be received. In some embodiments, a value of a buffer size (BS) field defining a range of buffer size may be predicted, in which case the model may apply a classification process, to classify the input values as corresponding to exactly one of the predetermined BS field values.

In some embodiments of the present technique, the gNB 801 may receive a representation of the model 808, which is stored in memory (not shown) of the gNB 801. Preferably, the memory is non-volatile memory.

In some embodiments, the AI/ML BSR prediction, compression or decompression algorithm may take into account the following factors on the UE side (UE based information):
RSRP/RSRQ value
Channel Status Information (CQI and calculated SRS)
power headroom (PHR)
survival time of data
frequency of BSR reporting
application layer status like L4S
size of current resource allocation (#RBs, MCS, TBS, etc.)

Based on one or more of these factors, the UE 811 determines the buffer size and compresses the information by encoding it into a buffer size value based on a buffer status table, and the gNB 801 decompresses the buffer size information by decoding the received buffer size value based on the same buffer status table.

The buffer size value represents an absolute value of the buffer size when a BSR is sent for the first time. For subsequent BSRs, the buffer size value represents the delta value of the updated buffer size compared to the absolute value of the buffer size reported in the first BSR.

In some embodiments, the UE 811 and/or the gNB 801 may use the above UE based information as well as other factors from the gNB side (gNB based information), for example:
cell load
uplink interference
application layer status like L4S

According to embodiments of the present technique, the above information is taken into account for the compressor and decompressor to establish a key performance indicator (KPI) or loss function and train the AI models. In some embodiments, the UE 811 may be asked to skip few iterations of BSR once the gNB 801 is confident of the predicted BSR values.

In some embodiments, the UE 811 may report actual or predicted value of buffer size. If the UE 811 reports predicted value, then the gNB 801 should be aware that it is a prediction and also aware how did the UE 811 come to this predicted value. In other words, a decompressor in the gNB 801 needs to be aware of the rules used by the compressor in the UE 811.

In some embodiments, this can be achieved by the UE 811 indicating a confidence level, in percentage and based on historical values of BSR, for a predicted value. If the actual value deviates from the predicted value, then the UE 811 sends a new BSR.

For input data, if a PDU from PDU set is discarded then related data from logical channel should also be discarded. Any such discard of data will have an impact on prediction of BSR on the gNB side. Therefore, in some embodiments, a BSR is triggered at the next available instance of BSR reporting when a packet from PDU set is discarded.

### Training of AI/ML Model

In some embodiments, the controllers 805, 815 of the gNB 801 and the UE 811 respectively comprise models 808, 818 based on machine learning. The machine learning may be performed separately, for example offline.

A representation of the resulting model may be stored in non-volatile memory on the UE 811 and/or the gNB 801. In some embodiments, a representation of the model is transmitted to the communications device (UE) 811 (and, in some embodiments, the infrastructure equipment (gNB) 801).

The training of the machine learning model may in some embodiments aim to minimize a loss function calculated based on input parameter values and selected BSR tables. That is, the model may iterate over a number of different values for the input parameters, and for each set of input parameter values, evaluate the loss function for different BSR tables.

In some embodiments, the loss function may be associated with the performance gap between the predicted buffer size and the actual buffer size. For example, the loss function may be defined as E=f [PBS, ABS], where PBS represents the predicted buffer size, ABS represents the actual buffer size used by the data, and f [ . . . ] represents a loss function definition. For example, ABS may represent the buffer size occupied by the data bits which were successfully transmitted or received. In some embodiments, the function f [ . . . ] corresponds to a mean squared error function E [ . . . ,], such that E [PBS, ABS] is defined as the average of a squared difference between PBS and ABS. In some embodiments, the loss function for compression, decompression and prediction of BSR may be implemented based on square generalized cosine similarity (SGCS). In some other embodiments, the loss function may be any other suitable function.

In some embodiments, the model comprises a plurality of weights associated with units and may be trained in accordance with the principles of the known back propagation method. For example, initially the output (loss function) is determined based on a set of input values (forward propagation) based on a test data set. Then a partial derivative (gradient) of the loss function with respect to a weight W from an output layer unit to input layer unit (back propagation) is calculated. Finally, the model updates the weight W according to the gradient of backpropagation.

In some embodiments, the training generates a model for estimating the buffer size for any input combination of BS table and input parameter values. For example, where BSTBL represents an index to a particular BS table, and I₁, . . . . I_{N} represent input parameter values, the model may determine a function f to estimate the expected loss E=f(BSTBL, I₁, . . . I_{N}). Accordingly, in operation, the controller 305, 304 may evaluate the expected loss E for a number of different BS tables jointly with the given input parameter values, and select the combination giving the lowest loss.

In some embodiments, the model may provide a classification. For example, the model may perform a function whose output is a vector, each element of the vector representing a different BS field value of a BS table, such that for a given combination of input values only one element of the vector, corresponding to the most efficient BS field value, is equal to one, with the other elements having a value of zero. Accordingly, the training may determine internal weights for nodes within a conventional classification neural network.

In some situations, the performance gap between the predicted buffer size and the actual buffer size may become wider and the AI algorithm may face difficulties in predicting the buffer size, for example, when large errors from the loss function occur. A fall back operation is therefore required. In some embodiments, the BSR prediction may be stopped or suspended for a period of time, and the UE may send the actual BSR more frequently. In some embodiments, an efficient solution is provided by actively controlled buffer size. For example, the active queue management (AQM) function may be enabled at the UE buffer or the gNB scheduler buffer if the error of prediction becomes large. In that case, some of the packets in the queue may be dropped intentionally if the queue length is getting larger and the risk of buffer overflow is high. As a result, buffer overflow and/or congestion can be avoided.

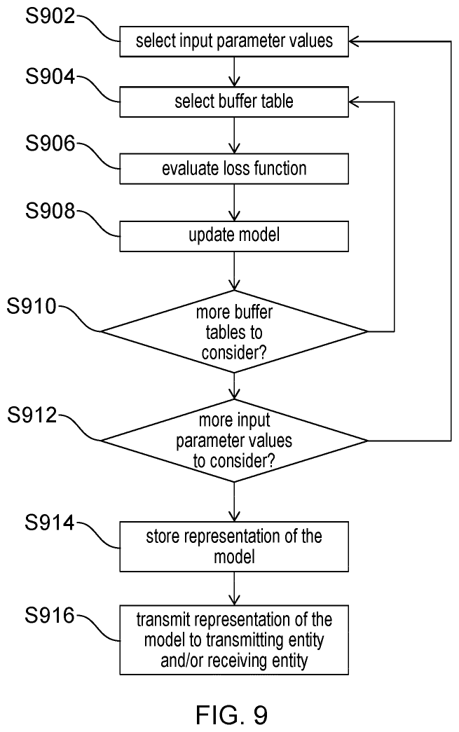

FIG. 9 illustrates a flow chart for a process carried out by a modelling entity within a communications device (UE) 811 and/or an infrastructure equipment (gNB) 801 adapted in accordance with embodiments of the present technique.

The process of FIG. 9 starts at step S902 in which values for one or more input parameters are determined. These may be determined in a deterministic manner (e.g. by selecting a next in sequence value from a predetermined range of values for each respective input parameter) or may be randomly selected. The method of selection may be different for different parameters: for example, parameters may be selected randomly, or may be increased in steps. According to embodiments of the present technique, the input parameters may be taken on the UE side (UE based information), for example:
RSRP/RSRQ value
Channel Status Information (CQI and calculated SRS)
power Headroom (PHR)
survival time of data
frequency of BSR Reporting
application layer status like L4S
size of current resource allocation (#RBs, MCS, TBS, etc.)

In some embodiments, the input parameters may be further taken on the gNB side (gNB based information), for example:
cell load
uplink interference
application layer status like L4S

At step S904, a buffer status table (BS table) is selected. This may be selected at random, selected based on the current version of the model, or selected in a deterministic manner (e.g. sequentially selected from a set of predetermined formats).

At step S906, a loss function corresponding to the BS table selected at step S904 and the input parameter values selected at step S902 is determined. Any suitable loss function may be used.

The loss function may be determined by simulation, or by data acquired corresponding to actual data transmissions.

Based on the loss function determined at step S906, the model is updated. The update may be automatic, in accordance with known machine learning techniques. For example, if the current (non-updated) model indicates that for the input parameter values selected at step S902 a particular format should be selected, and it is determined that the loss function determined at step S906 is lower for the BS table selected at step S904 than for the BS table currently suggested according to the model, then the model may be updated so that for the input parameter values selected at step S902, the BS table selected at step S904 is recommended by the updated model.

At step S910, it is determined if more BS tables are to be considered for the same input parameter values. If so, control returns to step S904, otherwise control continues to step S912.

At step S912, it is determined if further input parameter values are to be considered. If so, then control returns to step S902, otherwise control passes to step S914.

In step S914, a representation of the updated model is stored, for example on a computer-readable medium.

At step S916, a representation of the model is transmitted to the communications device and/or infrastructure equipment. The transmission in step S916 may be via a wireless access interface (such as via the wireless communications network shown in FIG. 8) or may be via a wired interface (such as during a manufacturing process).

The representation of the model transmitted at step S916 may be a reduced representation of the model stored at step S914. For example, the model stored at step S916 may comprise an indication of the value of the loss function determined at step S906, while the reduced model representation transmitted at step S916 may provide only a means to determine buffer size based on input parameter values.

According to embodiments of the present technique, a loss function is generated based on the input parameters (UE based information and/or gNB based information) for accommodating the performance gap between the transmitter and the receiver. The AI models may be updated and the prediction may be adjusted frequently based on the loss function.

### Model ID Handling

According to embodiments of the present technique, only one AI model is configured and used during the lifetime of a connection/service. In some embodiments, different models are supported for a connection, e.g., network may want to increase the accuracy of BSR and hence switch from legacy BSR to a new BSR. In this case, model IDs are configured using RRC signalling and any switching between these models may take place via MAC or PHY signalling. An AI/ML model may therefore be represented by a unique model ID. Separate model IDs may be assigned to Legacy BSR with AI/ML enhancements, New BSR table with AI/ML enhancements, one sided model, and two-sided model respectively. As such, model switching can be communicated by sending a model ID instead of configuring/sharing the whole configuration of the model.

In some embodiments, a new BSR table implicitly configures a new model ID. In some embodiments, BSR switching command implies that new model ID is currently in use.

### UE and gNB Capability Handling During UE Mobility

According to embodiments of present technique, a UE may switch from an old BSR scheme to a new BSR scheme during handover procedures from a source gNB to a target gNB in the following situations:
If the UE supports XR based BSR scheme and AI/ML enhancements for BSR in the source gNB, but the target gNB does not support either XR based BSR scheme or AI/ML enhancements for BSR.
If the UE supports one AI/ML model (or AI/ML model ID) in the source gNB, but the target gNB configures another AI/ML model. This may happen within the same gNB as well because different distributed units (DUs) may support different capabilities but still connected to the same centralized unit (CU).

Switching between an old BSR scheme and a new BSR scheme can be handled by signalling for handover between gNBs of different capabilities, for example, using delta signalling or setup/release signalling. Switching between AI/ML models (or AI/ML model IDs) may be handled in the same way.

There are no issues if one-sided model (UE side model or gNB side model) is used in the source gNB even if the target gNB does not support it. This is because one-sided model is free from interoperability issues.

However, if the source gNB uses two-sided model and the target gNB does not use the same AI/ML model, then there are two options according to some embodiments:
The source gNB releases AI/ML model configuration before handover: this option requires that the source gNB is aware of target cell capability. It will require an additional signalling.
The UE releases AI/ML model configuration on receiving a handover command: this option will lead to unnecessary release/setup if the target gNB supports the same configuration as the source gNB. However, this can be overcome if the target gNB provides an indication of whether the source configuration needs to be kept. For example, the target gNB may provide no model or a new model in a handover command.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to URLLC/IIOT devices or other low latency communications devices, but can be applied more generally, for example in respect of any type of communications device operating with a wireless link to the communication network.

It will further be appreciated that the principles described herein are applicable not only to LTE-based or 5G/NR-based wireless telecommunications systems, but are applicable for any type of wireless telecommunications system that supports a dynamic scheduling of shared communications resources.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of transmitting data by a communications device via a wireless communications network, the method comprising
receiving, at a transmit buffer, data for transmission via a wireless access interface of the wireless communications network,
determining, an initial buffer size required for transmitting the data based on an amount of data in the transmit buffer,
reporting an initial buffer status to an infrastructure equipment based on the absolute value of the initial buffer size,
determining an updated buffer size required for data transmission based on changes to the amount of data in the transmit buffer, and
reporting an updated buffer status to the infrastructure equipment based on the difference in the updated buffer size and the initial buffer size.

Paragraph 2. A method according to Paragraph 1, wherein the initial buffer status and the updated buffer status are reported per logical channel, and the priority of the data is indicated in the initial buffer status and updated buffer status per logical channel, in which high priority data in the transmit buffer is cleared first.

Paragraph 3. A method according to Paragraph 1, further comprising the step of
the communications device skipping the reporting of buffer status for a predetermined period of time, based on a command from the infrastructure equipment in the event that the infrastructure equipment is satisfied with the accuracy of the buffer status reported by the communications device.

Paragraph 4. A method according to Paragraph 1, wherein the reporting of the buffer status is triggered when a packet from PDU set is discarded.

Paragraph 5. A communications device comprising
transceiver circuitry configured to transmit data via a wireless communications network, and
controller circuitry configured in combination with the transceiver circuitry
   to receive, at a transmit buffer, data for transmission via a wireless access interface of the wireless communications network,
   to determine, an initial buffer size required for transmitting the data based on an amount of data in the transmit buffer,
   to report an initial buffer status to an infrastructure equipment based on the absolute value of the initial buffer size,
   to determine an updated buffer size required for data transmission based on changes to the amount of data in the transmit buffer, and
   to report an updated buffer status to the infrastructure equipment based on the difference in the updated buffer size and the initial buffer size.

Paragraph 6. Circuitry for a communications device comprising
transceiver circuitry configured to transmit data via a wireless communications network, and controller circuitry configured in combination with the transceiver circuitry
   to receive, at a transmit buffer, data for transmission via a wireless access interface of the wireless communications network,
   to determine, an initial buffer size required for transmitting the data based on an amount of data in the transmit buffer,
   to report an initial buffer status to an infrastructure equipment based on the absolute value of the initial buffer size,
   to determine an updated buffer size required for data transmission based on changes to the amount of data in the transmit buffer, and
   to report an updated buffer status to the infrastructure equipment based on the difference in the updated buffer size and the initial buffer size.

Paragraph 7. A method of receiving data by an infrastructure equipment via a wireless communications network, the method comprising:
receiving an initial buffer status from a communications device,
determining an initial buffer size for receiving the data based on the initial buffer status,
receiving an updated buffer status from the communications device,
determining the difference in an updated buffer size and the initial buffer size based on the updated buffer status, and
determining the updated buffer size for data reception by adding the difference to the initial buffer size.

Paragraph 8. A method according to Paragraph 7, wherein the initial buffer status and the updated buffer status are received per logical channel, and the priority of the data is indicated in the initial buffer status and updated buffer status per logical channel, in which high priority data in the receive buffer is cleared first.

Paragraph 9. An infrastructure equipment forming part of a wireless communications network, the infrastructure equipment comprising
transceiver circuitry configured to receive data from a communications device, and
controller circuitry configured in combination with the transceiver circuitry
   to receive an initial buffer status from a communications device,
   to determine an initial buffer size for receiving the data based on the initial buffer status,
   to receive an updated buffer status from the communications device,
   to determine the difference in an updated buffer size and the initial buffer size based on the updated buffer status, and
   to determine the updated buffer size for data reception by adding the difference to the initial buffer size.

Paragraph 10. Circuitry for an infrastructure equipment forming part of a wireless communications network, the infrastructure equipment comprising
transceiver circuitry configured to receive data from a communications device, and
controller circuitry configured in combination with the transceiver circuitry
   to receive an initial buffer status from a communications device,
   to determine an initial buffer size for receiving the data based on the initial buffer status,
   to receive an updated buffer status from the communications device,
   to determine the difference in an updated buffer size and the initial buffer size based on the updated buffer status, and
   to determine the updated buffer size for data reception by adding the difference to the initial buffer size.

Paragraph 11. A wireless communications system comprising a communications device according to Paragraph 5 and an infrastructure equipment according to Paragraph 9.

Paragraph 12. A computer program comprising instructions which, when loaded onto a computer, cause the computer to perform a method according to Paragraph 1 or Paragraph 7.

Paragraph 13. A non-transitory computer-readable storage medium storing a computer program according to Paragraph 12.

Paragraph 14. A method of transmitting data by a communications device via a wireless communications network, the method comprising
receiving, at a transmit buffer, data for transmission via a wireless access interface of the wireless communications network,
   determining a value of one or more input parameters,
   predicting an initial buffer size required for transmitting the data using a first model at the communications device, based on an amount of data in the buffer and the value of each of the one or more input parameters,
reporting an initial buffer status to an infrastructure equipment based on the absolute value of the initial buffer size,
predicting an updated buffer size required for data transmission using the first model, based on the updated amount of data in the transmit buffer and updated value of each of the one or more input parameters, and
reporting an updated buffer status to the infrastructure equipment based on the difference in the updated buffer size and the initial buffer size,
wherein the first model is trained using machine learning.

Paragraph 15. A method according to Paragraph 14, wherein the initial buffer status and the updated buffer status are reported per logical channel, and the priority of the data is indicated in the initial buffer status and updated buffer status per logical channel, in which high priority data in the transmit buffer is cleared first.

Paragraph 16. A method according to Paragraph 14, wherein the input parameters include parameters of the communications device and comprise one or more of
RSRP value,
RSRQ value,
channel status information,
power headroom,
survival time of data,
frequency of reporting buffer status reports,
application layer status, and
size of current resource allocation.

Paragraph 17. A method according to Paragraph 16, wherein the input parameters further include parameters provided by the infrastructure equipment and comprise one or more of
cell load,
congestion,
uplink interference, and
application layer status.

Paragraph 18. A method according to Paragraph 14, further comprising the step of
generating a loss function for accommodating the performance gap between the buffer size predicted by the first model and the actual buffer size, and
updating the first model based on the loss function.

Paragraph 19. A method according to Paragraph 14, further comprising the step of
generating a loss function for accommodating the performance gap between the buffer size predicted by the first model and the buffer size predicted by a second model, wherein the second model is used by the infrastructure equipment to predict the buffer size required for data reception, and the second model is trained using machine learning, and
updating the first model based on the loss function.

Paragraph 20. A method according to Paragraph 14, further comprising the step of
the communications device skipping the reporting of buffer status for a predetermined period of time, based on a command from the infrastructure equipment in the event that the infrastructure equipment is satisfied with the accuracy of the buffer status reported by the communications device.

Paragraph 21. A method according to Paragraph 14, further comprising the step of
the communications device indicating to the infrastructure equipment if the reported buffer status is based on a predicted buffer size and the manner of calculating the predicted buffer size. Paragraph 22. A method according to Paragraph 14, wherein the reporting of the buffer status is triggered when a packet from PDU set is discarded.

Paragraph 23. A method according to Paragraph 14, further comprising the step of
the communications device increasing the accuracy of the buffer status report by switching from a legacy buffer status report scheme to a new buffer status report scheme based on a switching command received from the infrastructure equipment.

Paragraph 24. A method according to Paragraph 23, wherein the switching command indicates that a new model is in use.

Paragraph 25. A method according to any of Paragraphs 14 to 24, wherein the communications device is a user equipment.

Paragraph 26. A method according to Paragraph 25, further comprising the step of
in the event of handover, the user equipment releasing model configuration on receiving handover command if a target radio network infrastructure equipment has no model or uses a model different from the model at a source radio network infrastructure equipment.

Paragraph 27. A communications device comprising
transceiver circuitry configured to transmit data via a wireless communications network, and
controller circuitry configured in combination with the transceiver circuitry
   to receive, at a transmit buffer, data for transmission via a wireless access interface of the wireless communications network,
to determine a value of one or more input parameters,
to predict an initial buffer size required for transmitting the data using a first model at the communications device, based on an amount of data in the buffer and the value of each of the one or more input parameters,
   to report an initial buffer status to an infrastructure equipment based on the absolute value of the initial buffer size,
   to predict an updated buffer size required for data transmission using the first model, based on the updated amount of data in the transmit buffer and updated value of each of the one or more input parameters, and
   to report an updated buffer status to the infrastructure equipment based on the difference in the updated buffer size and the initial buffer size,
   wherein the first model is trained using machine learning.

Paragraph 28. Circuitry for a communications device comprising
transceiver circuitry configured to transmit data via a wireless communications network, and
controller circuitry configured in combination with the transceiver circuitry
   to receive, at a transmit buffer, data for transmission via a wireless access interface of the wireless communications network,
   to determine a value of one or more input parameters,
   to predict an initial buffer size required for transmitting the data using a first model at the communications device, based on an amount of data in the buffer and the value of each of the one or more input parameters,
   to report an initial buffer status to an infrastructure equipment based on the absolute value of the initial buffer size,
   to predict an updated buffer size required for data transmission using the first model, based on the updated amount of data in the transmit buffer and updated value of each of the one or more input parameters, and
   to report an updated buffer status to the infrastructure equipment based on the difference in the updated buffer size and the initial buffer size,
wherein the first model is trained using machine learning.

Paragraph 29. A method of receiving data by an infrastructure equipment via a wireless communications network, the method comprising:
receiving an initial buffer status from a communications device, determining a value of one or more input parameters,
predicting an initial buffer size required for receiving the data using a first model at the infrastructure equipment, based on the initial buffer status and the value of each of the one or more input parameters,
receiving an updated buffer status from the communications device,
determining the difference in an updated buffer size and the initial buffer size based on the updated buffer status,
determining the updated buffer size by adding the difference to the initial buffer size,
predicting a receive buffer size for data reception, based on updated buffer size and updated value of each of the one or more input parameters, and
wherein the first model is trained using machine learning.

Paragraph 30. A method according to Paragraph 29, wherein the initial buffer status and the updated buffer status are reported per logical channel, and the priority of the data is indicated in the initial buffer status and updated buffer status per logical channel, in which high priority data in the receive buffer is cleared first.

Paragraph 31. A method according to Paragraph 29, wherein the input parameters include parameters of the communications device and comprise one or more of
RSRP value,
RSRQ value,
channel status information,
power headroom,
survival time of data,
frequency of reporting buffer status reports,
application layer status, and
size of current resource allocation.

Paragraph 32. A method according to Paragraph 31, wherein the input parameters include parameters of the infrastructure equipment and comprise one or more of
cell load,
congestion,
uplink interference, and
application layer status.

Paragraph 33. A method according to Paragraph 29, further comprising the step of
generating a loss function for accommodating the performance gap between the buffer size predicted by the first model and the actual buffer size, and
updating the first model based on the loss function.

Paragraph 34. A method according to Paragraph 29, further comprising the step of
generating a loss function for accommodating the performance gap between the buffer size predicted by the first model and the buffer size predicted by a second model, wherein the second model is used by the communications device to predict the buffer size required for data transmission, and the second model is trained using machine learning, and
updating the first model based on the loss function.

Paragraph 35. A method according to Paragraph 29, further comprising the step of
the infrastructure equipment directing the communications device to skip reporting of buffer status for a predetermined period of time, in the event that the infrastructure equipment is satisfied with the accuracy of the buffer size predicted by the infrastructure equipment.

Paragraph 36. A method according to Paragraph 29, further comprising the step of
the infrastructure equipment receiving an indication from the communications device if the reported buffer status is based on a predicted buffer size and the manner of calculating the predicted buffer size.

Paragraph 37. A method according to Paragraph 29, wherein the reporting of the buffer status is triggered when a packet from PDU set is discarded.

Paragraph 38. A method according to Paragraph 29, further comprising the step of
the infrastructure equipment increasing the accuracy of the buffer status report by sending a switching command to the communications device instructing the communications device to switch from a legacy buffer status report scheme to a new buffer status report scheme.

Paragraph 39. A method according to Paragraph 29, wherein the switching command indicates that a new model is in use.

Paragraph 40. A method according to Paragraph 29, further comprising the step of
in the event of handover, a source radio network infrastructure equipment releasing model configuration before handover if a target radio network infrastructure equipment has no model or uses a model different from the model at the source radio network infrastructure equipment.

Paragraph 41. A method according to Paragraph 29, further comprising the step of
in the event of handover, a target radio network infrastructure equipment providing no model or a new model in a handover command if the target radio network infrastructure equipment has no model or uses the new model different from the model at a source radio network infrastructure equipment.

Paragraph 42. An infrastructure equipment forming part of a wireless communications network, the infrastructure equipment comprising
transceiver circuitry configured to receive data from a communications device, and
controller circuitry configured in combination with the transceiver circuitry
   to receive an initial buffer status from a communications device,
to determine a value of one or more input parameters,
   to predict an initial buffer size required for receiving the data using a first model at the infrastructure equipment, based on the initial buffer status and the value of each of the one or more input parameters,
   to receive an updated buffer status from the communications device,
   to determine the difference in an updated buffer size and the initial buffer size based on the updated buffer status,
   to determine the updated buffer size by adding the difference to the initial buffer size,
   to predict a receive buffer size for data reception, based on updated buffer size and updated value of each of the one or more input parameters, and
   wherein the first model is trained using machine learning.

Paragraph 43. Circuitry for an infrastructure equipment forming part of a wireless communications network, the infrastructure equipment comprising
transceiver circuitry configured to receive data from a communications device, and
controller circuitry configured in combination with the transceiver circuitry
   to receive an initial buffer status from a communications device,
to determine a value of one or more input parameters,
   to predict an initial buffer size required for receiving the data using a first model at the infrastructure equipment, based on the initial buffer status and the value of each of the one or more input parameters,
   to receive an updated buffer status from the communications device,
   to determine the difference in an updated buffer size and the initial buffer size based on the updated buffer status,
   to determine the updated buffer size by adding the difference to the initial buffer size,
   to predict a receive buffer size for data reception, based on updated buffer size and updated value of each of the one or more input parameters, and
   wherein the first model is trained using machine learning.

Paragraph 44. A wireless communications system comprising a communications device according to Paragraph 27 and an infrastructure equipment according to Paragraph 42.

Paragraph 45. A computer program comprising instructions which, when loaded onto a computer, cause the computer to perform a method according to Paragraph 14 or Paragraph 29.

Paragraph 46. A non-transitory computer-readable storage medium storing a computer program according to Paragraph 45.

### REFERENCES

[1] 3GPP TS 38.300 v. 15.2.0 “NR; NR and NG-RAN Overall Description; Stage 2 (Release 15)”, June 2018
[2] TS38.322, “Radio Link Control (RLC) protocol specification”, Release 17
[3] TS38.323, “Packet Data Convergence Protocol (PDCP) specification”, Release 17
[4] Holma H. and Toskala A, “LTE for UMTS OFDMA and SC-FDMA based radio access”, John Wiley and Sons, 2009
[5] TR38.835, “Study on XR enhancements for NR”, Release 18
[6] TS38.321, “Medium Access Control (MAC) protocol specification”, Release 17
[7] TS22.261 “Service requirements for the 5G system” (Release 17)

1. A method of transmitting data by a communications device via a wireless communications network, the method comprising
receiving, at a transmit buffer, data for transmission via a wireless access interface of the wireless communications network,
determining, an initial buffer size required for transmitting the data based on an amount of data in the transmit buffer,
reporting an initial buffer status to an infrastructure equipment based on the absolute value of the initial buffer size,
determining an updated buffer size required for data transmission based on changes to the amount of data in the transmit buffer, and
reporting an updated buffer status to the infrastructure equipment based on the difference in the updated buffer size and the initial buffer size.

2. A method according to claim 1, wherein the initial buffer status and the updated buffer status are reported per logical channel, and the priority of the data is indicated in the initial buffer status and updated buffer status per logical channel, in which high priority data in the transmit buffer is cleared first.

3. A method according to claim 1, further comprising the step of
the communications device skipping the reporting of buffer status for a predetermined period of time, based on a command from the infrastructure equipment in the event that the infrastructure equipment is satisfied with the accuracy of the buffer status reported by the communications device.

4. A method according to claim 1, wherein the reporting of the buffer status is triggered when a packet from PDU set is discarded.

5. A communications device comprising
transceiver circuitry configured to transmit data via a wireless communications network, and
controller circuitry configured in combination with the transceiver circuitry
to receive, at a transmit buffer, data for transmission via a wireless access interface of the wireless communications network,
to determine, an initial buffer size required for transmitting the data based on an amount of data in the transmit buffer,
to report an initial buffer status to an infrastructure equipment based on the absolute value of the initial buffer size,
to determine an updated buffer size required for data transmission based on changes to the amount of data in the transmit buffer, and
to report an updated buffer status to the infrastructure equipment based on the difference in the updated buffer size and the initial buffer size.

6.-8. (canceled)

9. An infrastructure equipment forming part of a wireless communications network, the infrastructure equipment comprising
transceiver circuitry configured to receive data from a communications device, and
controller circuitry configured in combination with the transceiver circuitry
to receive an initial buffer status from a communications device,
to determine an initial buffer size for receiving the data based on the initial buffer status,
to receive an updated buffer status from the communications device,
to determine the difference in an updated buffer size and the initial buffer size based on the updated buffer status, and
to determine the updated buffer size for data reception by adding the difference to the initial buffer size.

10.-46. (canceled)
